(19) United States
(12) Patent Application Publication
(10) Pub. No.: US 2003/0084818 A1
(43) Pub. Date: May 8, 2003

(54) Starch based adhesive

(76) Inventors: Denise Pelley, Piscataway, NJ (US); Daniel B. Solarek, Hillsborough, NJ (US); Judith K. whaley, Hillsborough, NJ (US); Rajal Dhruva, Danbruy, CT (US)

Correspondence Address: Cynthia L. Foulke, NATIONAL STARCH AND CHEMICAL COMPANY, 10 Finderne Avenue, Bridgewater, NJ, 08807-0500, US

(21) Appl. No.: 09/922,089

(22) Filed: Aug. 3, 2001

(51) Int. Cl. C 09J 1 3/04; C13K 1/00

(52) U.S. Cl. 106/206.1; 106/215.5; 493/243; 493/264; 229/68.1

(57) ABSTRACT

An adhesive comprising a converted starch derivative which has a flow viscosity of from about 7 to about 20 seconds.

### FIELD OF THE INVENTION

The invention relates to the field of adhesives. More specifically, the invention relates to starch based adhesives and to articles, in particular envelopes, comprising such adhesives.

### BACKGROUND OF THE INVENTION

Machinery used in the forming of envelopes is designed to perform in a continuous manner by the passage of material from end-to-end of the machine in rolling contact with various instrumentalities thereof whereby paper blanks are folded and formed into envelopes. Glue, adhesive or gum must be applied to precisely designated areas of the envelope blank during transit of the envelope blank through the machine. A double outside seam business envelope, for example, is manufactured from a paper blank by folding generally triangular end flaps inwardly against a rectangular front panel of the envelope. Adhesive is then applied to specific surface areas of the end flaps (i.e., in the area where the end flaps and back flap will overlap). A back panel or flap is folded upwardly against the end flaps and sealed to the end flaps by the adhesive which was applied to the end flaps.

Machines used for manufacture of envelopes are commonly designed to apply the gum by a stencil roller. The stencil roller receives the glue from a roller with which it comes in contact and it then transfers the gum onto the envelope blank. It will be readily appreciated that, in order that the apparatus may operate properly, the gum must be spread very evenly on the transfer roller and without defects in the gum. In one conventionally used method, the layer of gum is applied using a primary roller whose periphery resides in a body of gum and which contacts the transfer roller while rotating in the same direction, so that the gum resides in a small pool in the nip between the two rollers. The thickness of the layer of gum which is lifted from the gum box by the primary roller and carried over to the transfer roller is regulated by a blade or roller whose operative edge is fixed in spaced relationship to the surface of the primary roller, so that only the desired amount of gum passes through this gap and the excess is scraped back into the gum box.

Changes in viscosity of the gum can cause large changes in the thickness of the coat. Too much gum is wasteful of the expensive gum while too thin a coat results in an inoperative envelope. This arrangement also result in churning of the gum. Thus the gum is mixed with oxygen and, therefore, may oxidize and thicken. Bubbles of hardened glue may pass on to the envelope as well as hardened particles that may accumulate on the blade roller before eventually being released and passed on to the transfer mechanism. Churning may also cause a hardening of the glue on the edge of the blade that results in localized streaking and results in an envelope whose appearance is less than desirable and whose elements are not properly adhered together.

There continues to be a need in the art for adhesives useful as a seam gum adhesive in envelope converting machinery that can be safely manufactured, has good viscosity stability, good wet tack and good machining characteristics. The current invention addresses this need in the art.

### SUMMARY OF THE INVENTION

The invention provides adhesive formulations that are particularly advantageous for use as seam gum adhesives in the manufacture of envelopes.

One aspect of the invention is directed to an adhesive comprising a converted starch derivative having a flow viscosity of between about 7 and about 20 seconds. The adhesive formulations preferably further comprise a salt, a humectant, and/or a resin emulsion. Preferred for use are octenylsuccinic anhydride modified starches and/or propylene oxide modified starches.

Another aspect of the invention is directed to an article of manufacture comprising a converted starch derivative having a flow viscosity of between about 7 seconds and about 20 seconds. In one embodiment the article is an envelope.

Still another aspect of the invention is directed to a method of making an envelope comprising applying an adhesive comprising a converted starch derivative having a flow viscosity of between about 7 and about 20 seconds to an envelope blank. In one embodiment the envelope blank is at least partially folded prior to application of the adhesive.

### DETAILED DESCRIPTION OF THE INVENTION

The disclosures of all references cited herein are incorporated in their entireties by reference.

Stable viscosity and good machining characteristics are two critical properties for an adhesive that is applied to a substrate via a stencil roller. Also important are good adhesion, good wet tack, acceptable penetration blocking, and good drying speed.

In order to provide the desired processing properties on the converting equipment it is critical to obtain the proper balance of viscosity and percent solids.

Viscosity stability refers to the viscosity of the adhesive over a given time. Generally a viscosity increase of less than about 50% over a one month period of time is considered acceptable for use as a seam gum adhesive.

Wet tack refers to the related stickiness of the adhesive in its wet state. This property gives the adhesive the ability to hold the substrate in place as the envelope is being made on the converting equipment.

Penetration blocking is the tendency of the adhesive to penetrate the substrate and remoisten the seal gum. This results in premature adhesion of the envelope flap over the bonded area. The common cause of this problem is water migration out of the bond line during drying.

Drying speed is a measure of how long it will take for an adhesive to dry completely. This correlates with the gumbox stability of the adhesive. If it takes a long time for the adhesive to dry, it will not dry out in the gumbox. On the other hand, if the adhesive dries rather quickly, it may dry out in the gumbox and machine poorly.

Adhesion is a measurement of how well the adhesive formulation adheres to a variety of substrates.

Observations indicative of the quality of the adhesive's machining characteristics include (1) the quantification of splash and/or throw resistance from the roller and/or stencil, (2) whether adhesive drips from the gumbox while running, (3) the way the adhesive coats the roller, (4) the ease of clean up and (5) the general behavior of the adhesive in the gumbox while being sheared. Observations can also be made of any changes exhibited in the gumbox as the speed is held constant or increased. These observations also give an indication of the maximum line speed at which the adhesive will operate.

It has now been discovered that a converted starch with a flow viscosity between about 7 and about 20 seconds, more preferably between about 7 and about 12, even more preferably between about 9 and about 11 seconds, which starch contains functional groups, can be safely manufactured, has an unexpected gain in viscosity stability, good adhesion to a variety of stocks, including kraft, white wove, and bond stocks, good wet tack, acceptable penetration blocking, good drying speed and good machining characteristics when used in envelope converting machinery. Preferably, the modified starch is blending with polysaccharides to prepare the adhesive formulations of the invention. The adhesives of the invention have a solids content of up to about 70% or higher, typically from about 40 to about 70%.

The present invention provides an adhesive comprising a converted starch derivative having a flow viscosity of between about 7 and about 20 seconds. In preparing the converted starch derivative for use in the practice of the invention, starch may be derivitized and then converted, or converted and then derivitized. Use of the term “converted starch derivative” encompasses both.

The starch may be converted using a fluid bed or dry bed process. As noted above, in preparing the converted starch derivative for use in the practice of the invention, derivatization may occur before or following conversion.

The starch material used as the starting base material may be obtained from any source. By “base” starch is meant raw or native starch, i.e., starch as it comes from the plant source. Such base starch include natural starches as well as genetically altered and hybrid starches. Suitable starches which may be used to practice the invention include starch derived from potato, maize (corn), tapioca, sago and rice. A starch known in the art as waxy maize, which is a genetic hybrid, may also be used in the practice of the invention.

The preparation of an esterified or etherified modified starch, referred to herein as a starch derivative, can be carried out by procedures known in the art. One such method is disclosed in U.S. Pat. No. 2,661,349, which describes hydrophobic starch derivatives such as starch alkyl or alkenyl succinates. The '349 patent describes an aqueous method in which such derivatives are prepared using a standard esterification reaction where the anhydride reagent and starch are suspended in water and mixed under alkaline conditions. Another method for preparing hydrophobic starch derivatives is disclosed in U.S. Pat. No. 5,672,699. This patent describes a method for preparing hydrophobic starch derivatives having improved reaction efficiencies wherein the starch and anhydride reagent are predispersed or intimately contacted at low pH before being brought to alkaline reaction conditions. Other disclosures of the starch derivatives and the method of preparation can be found in “Starch: Chemistry and Technology”, second edition, edited by R. L. Whistler et al., 1988, pp. 341-343 and “Modified Starches: Properties and Uses”, edited by O. Wurzburg, 1986, Chapter 9, pp. 131-147.

The starch derivative can be prepared by reacting a starch and an organic anhydride. Preferred organic anhydrides include octenyl succinic anhydride, dodecenyl succinic anhydride and hexadecenyl succinic anhydride. While octenyl succinic anhydride (OSA)-modified maize starch is one preferred embodiment, and is exemplified herein, the invention is not limited thereto. The amount of the derivative group will be from about 1 to about 10% and preferably from about 2 to about 5% by weight, based on the weight of dry starch.

In another embodiment, the modified starch is a propylene oxide (PO)-modified starch. Starch may be derivatized using propylene oxide as follows. An aqueous starch slurry containing from about 5 to about 40%, particularly 30 to 40%, solids is prepared. From about 20 to about 30% percent sodium sulfate based on the weight of the starch is added. The pH is then adjusted to from about 11 to about 13 by addition of a 3% sodium hydroxide solution in an amount of from about 40 to about 60% based upon the weight of the starch. The desired amount of propylene oxide is added. The temperature is brought to the range of about 35 to 50° C., particularly about 40° C., and the process is allowed to continue for about 18 to about 24 hours. The amount of the derivative group will be from about 1 to about 10% and preferably from about 4 to about 7% by weight, based on the weight of dry starch.

The starch may be degraded or converted by any means known in the art. Particularly suitable starches for use in the practice of the invention are conversion products, including fluidity or thin-boiling starches prepared by oxidative hydrolysis, acid hydrolysis, enzyme conversion, heat and/or acid dextrinization, or a combination thereof, as are products made from blends thereof. Particularly suitable conversion products are those prepared by oxidation or acid conversion.

In commercial practice, starch is ordinarily converted by acid or enzyme conversion techniques. One developed process for degradation of granular starch involves a process employing hydrogen peroxide and a manganese salt catalyst such as potassium permanganate in alkaline slurry.

In the preparation of converted starches by acid treatment, the granular starch base is hydrolyzed to the required viscosity in the presence of an acid, such as sulfuric or hydrochloric acid, at a temperature below the gelatinization point of the starch. The starch is slurried in water and the acid, usually in concentrated form, is then added.

Typically, the reaction takes place over an 8 to 24 hour period or longer, more typically from about 12 to about 20 hours, after which the acid is neutralized with alkali (e.g., to a pH of 5.5). The starch is recovered after neutralization by filtration from water and dried to produce a powder.

The converted starch may alternatively be prepared by enzyme treatment as known in the art. For example, the granular starch base may be slurried in water and the pH adjusted to about 5.6 to 5.7 with alkali or acid. A small amount of alpha-amylase enzyme (e.g., about 0.02% on the starch) is then added to the slurry, which is heated above the gelatinization point of the starch. When the desired conversion is reached, the pH is adjusted with acid (e.g., to about 2.0) to deactivate the enzyme and the dispersion is held at the pH for a period of at least 10 minutes. Thereafter the pH may be readjusted. The resulting converted starch is usually jet-cooked to ensure complete solubilization of the starch and deactivation of the residual enzyme. The type and concentration of the enzyme, the conversion conditions, and the length of conversion all will contribute to the composition of the resultant product. In the alternative, another enzyme or a combination of enzymes may be used.

Hydrogen peroxide may also be used on the starch as a converting (thinning) agent, either alone or together with metal catalysts. U.S. Pat. No. 3,655,644 discloses a method of thinning derivatized starch using hydrogen peroxide and a copper ion catalyst. U.S. Pat. No. 3,975,206 discloses an improved method for thinning starch employing hydrogen peroxide in combination with heavy metal salt catalysts such as iron, cobalt, copper or chromium, at an acid pH. This patent further lists a number of references directed to degrading (thinning) starch with hydrogen peroxide under a variety of conditions. U.S. Pat. No. 4,838,944 discloses a process for the degradation of granular starch using hydrogen peroxide and a catalytic amount of manganese salt, preferably potassium permanganate, in an aqueous slurry at a pH of 11.0 to 12.5. U.S. Pat. No. 5,833,755 discloses a process for degrading granular starch with hydrogen peroxide at a temperature below the gelatinization temperature of the starch, the steps comprise providing an aqueous slurry of granular starch at a pH of 11.0 to 12.5, adding an effective catalytic amount of a metal complex catalyst to the aqueous slurry, adding said hydrogen peroxide to the aqueous slurry in an effective amount to degrade the granular starch.

Whereas previously acid modified starches have been produced by dispersing the starch in water and adding acid to the mixture, it has now been discovered that starch treated with an anhydrous mineral acid in a dry state and treated at a particular temperature and for a particular time produces a starch having a particular viscosity when cooked in water. Unexpectedly, such a process allows for the preparation of converted starch which retains lower molecular weight components that would previously have been lost during dewatering steps.

While products similar to those produced using a conventional aqueous method can be produced using this method, it has been discovered that products that have a higher degree of conversion, which products cannot easily be recovered from water, can be accomplished by reacting the starch in a dry state. It has been discovered that mixing a base starch with acid, drying the mixture to a substantially anhydrous state and heating the dried mixture for a sufficient time may advantageously be used to produce a converted starch having a desired funnel flow viscosity. By a substantially anhydrous state means the starch mixture is dried to a moisture content of less than about 1%.

Various process methods can be used to produce these compositions in a dry state. Batch and continuous processes that are characterized by excellent mass and heat transfer rates are the most suitable. Examples of these processes are Fluid bed reactor, a thin layer thermal reactor with convective airflow and a pressurized mixer equipped with vacuum and heated jacket. The starches are characterized by their funnel viscosity measurements.

Generally, a base starch having less than about 18% moisture, is placed into a reactor having a convective and conductive energy source. Such reactors include, without limitation, a fluidized bed, a thin layer thermal reactor or a pressurized mixer equipped with vacuum and a heated jacket. A fluidizing gas (e.g. air) is then introduced at a rate whereby the starch is suspended in the reactor bed. Anhydrous acid (e.g. hydrochloric acid) and a carrier gas (e.g. nitrogen), are injected directly into the fluidizing gas of the fluidized reactor to effect the mixture of the starch and acid.

The temperature of the bed is increased to a temperature in the range of between about 50 to about 135° C. The increase in temperature may be accomplished by means well known in the art including, without limitation, an oil-heated jacket or via a heated air source, or combinations thereof. Depending on the degree of acidification and initial moisture content, the reaction is typically completed within about 3 minutes to about one hour. Where the process is continuous, the process typically takes from about 3 minutes to about 30 minutes. A batch process is typically completed in from about 30 minutes to about one hour. While the reaction is substantially complete in less than about one hour, longer periods of heating, e.g. up to about 6 to about 8 hours or more, may be used without substantial deterioration of the final converted product. After the process is complete, the reactor is cooled and the starch discharged and used without the need for further purification.

The process of the invention enables the production of highly converted starches in a highly controlled and reproducible manner having a composition that would not allow for recovery if reacted in the presence of water (i.e., traditional aqueous batch processing). These compositions can be tailored to retain lower molecular weight components that would previously have been lost during dewatering steps. These starch compositions result in unique performance when evaluated in adhesive applications which sometimes require low molecular weight sugars to be added to the formulation. This process when accomplished in the dry state may advantageously be used to prepare an adhesive in accordance with the practice of the invention. For use in the preparation of an adhesive, conversion is continued until the starch has a flow viscosity of from about 7 to about 20 seconds. When used to prepare an adhesive formulation for use as a seam gum adhesive in the manufacture of envelopes, the conversion process is preferably allowed to continue until the flow viscosity of the converted starch derivative is from about 7 seconds to about 12 seconds, even more preferably from about 9 to about 11 seconds.

Flow viscosity, also referred to herein as funnel viscosity, is measured using a fixed orifice viscosity funnel, and is a measurement of the time it takes 100 mL of the cook to pass through the orifice.

The funnel used to measure flow viscosity is a standard 58 degree, thick-wall, heat resistant glass funnel whose top diameter is about 9 to about 10 cm with the inside diameter of the stem being about 0.381 cm. The glass stem of the funnel is cut to an approximate length of 2.86 cm from the apex, carefully fire-polished, and refitted with a long stainless steel tip which is about 5.08 cm long with an outside diameter of about 0.9525 cm. The interior diameter of the steel tip is about 0.5952 cm at the upper end where is attached to the glass stem and about 0.4445 cm at the outflow end with the restriction in the width occurring at about 2.54 cm from the ends. The steel tip is attached to the glass funnel by means of a Teflon tube. The funnel is calibrated so as to allow 100 mL of water to go through in six seconds using the described procedure (see Example 1).

The method of measuring funnel flow viscosity is described in detail in Example 1.

As described above, converted starches which may be used in the practice of the invention contain functional groups. Preferred for use are converted starches derivatized with octenylsuccinic anhydride (OSA) or propylene oxide (PO). In a particularly preferred embodiment of the invention the starch is derivatized with OSA or PO, and then treated with an anhydrous mineral acid in a dry state at a temperature of from 95° C. to about 130° C. for about 15 minutes to about one hour.

The converted starch derivative is advantageously formulated with salts, humectants, and/or resin emulsions to provide the required tack, overall adhesion, solution viscosity, stability, and/or desired rheological characteristics.

The particular salt, when used, is not critical, and can be selected from many available salts. Nonlimiting examples include magnesium chloride, sodium chloride and sodium nitrate. The salt is typically used in amounts up to about 35%. Amounts of about 8 to about 33% are preferred.

The humectant used may be any of those conventionally used in formulating adhesives. Typical humectants include sugars, sorbitol, glycerin and related derivatives, urea, propylene glycol and similar related glycols and glycol ether. The humectants are used in the adhesive formulation at levels of about 0.5% to about 10% by weight, and typically about 5%. Preferably dextrose, maltose or other polysaccharides is used as humectant.

Resin emulsion may be used to provide better wet tack. Ideally, the resin emulsion is chosen from those homopolymers or copolymers that have been dextrin-stabilized. The amount of resin emulsion used is from about 0 to about 50%, typically from about 20 to about 40%. Non-limiting examples include ethylene vinyl acetate and polyvinyl acetate that are dextrin or polyvinyl alcohol stabilized.

Various additional optional additives, including defoamers, plasticizers, preservatives, thickeners, bleaching agents, optical brighteners, UV indicators and peptizing salts such as magnesium chloride and sodium nitrate, may also be present in the adhesive compositions in order to modify certain characteristics thereof.

The adhesives bases upon this type of starch result in excellent machining characteristics on converting equipment, which use stencil rollers for transferring the adhesive. A reduction in the amount of adhesive, which is thrown, dripped or splashed from the stencils or adhesive pan is observed when the adhesive is used. The adhesive will work well for a broad range of equipment and applications, in particular those using a stencil roller, and is an ideal adhesive for envelope converting machines.

While the adhesive finds particular use as a seam gum adhesive used to manufacture envelopes, other uses are clearly contemplated and are encompassed by the invention. The adhesive described herein may be used in the fabrication of corrugated board, paper bags, paper boxes, laminated paperboard, books, spiral-wound tubes, gummed labels, gummed tapes and in other gumming applications.

The practice of the invention is not limited to any particular envelope configuration. Any envelope manufactured with the adhesive described herein, without regard to configuration, is encompassed by the invention. Both conventional mailing type envelopes, i.e., those with a front flap, and open top envelopes, e.g, for storage of a diskette or the like, are encompassed by the invention.

The invention can be illustrated by the following non-limiting examples.

### EXAMPLES

### Example 1

This example describes a method whereby funnel flow viscosity may be measured.

The starch is collected and dried to below 12% moisture. After the moisture content is determined, tare a stainless steel beaker and thermometer. Add 19% starch to distilled water for a total of 300 g of starch and water. Cook the mixture in a boiling water bath for 15 minutes, stirring for the first 5 minutes. Cover the stainless steel beaker for the remaining 10 minutes. After the cook is complete, remove the beaker from the boiling water bath and cool to 80° F. Bring the beaker back to the original weight before the cook with distilled water and continue cooling to 72° F. Transfer the contents of the beaker to a 100 mL cylinder. Place a finger over the orifice of the funnel and pour the contents from the cylinder into the funnel. Allow a small amount to flow back into the cylinder to remove trapped air. Pour the balance back into the funnel, invert the cylinder over the funnel, and allow the contents to drip from the cylinder into the funnel. Remove the finger from the orifice of the funnel and time the sample until the 100 mL flow through the apex of the funnel. This time is the flow viscosity of the starch sample.

### Example 2

This Example describes a method of preparing a converted starch by acid hydrolysis via an aqueous slurry.

Raw starch (available from National Starch and Chemical Co.) was slurried with tap water. The starch can be a variety of raw starch, such as maize, sago, waxy, etc. The slurry container was placed in a constant temperature bath set to 52.5° C. and allowed to equilibrate to 52° C. A hydrochloric acid, 37% solution (available from Fisher Scientific) was added and allowed to react for an amount of time need to obtained a desired flow viscosity. The reaction was neutralized to a pH of ˜4.5 with slow addition of sodium carbonate as needed. Converted starch Samples A and B prepared by this method are shown in Table 1.

TABLE 1

| | Sample A | Sample B |
|---|---|---|
| Starch (g): | | |
| sago | 5000 | |
| maize | | 5000 |
| Water (g) | 6250 | 6250 |
| HCl (37%) (g) | 500 | 500 |
| Time (hours) | 24 | 24 |
| Flow viscosity (seconds) | 12.0 | 11.0 |

### Example 3

This Example describes a method of preparing an OSA derivatized starch.

The starch slurries of Samples A and B were adjusted to a pH of ˜7.5 with 3% NaOH solution. When the pH reached 7.5, the OSA was added, about ⅓ at a time every 15 minutes. A total of 150 g of OSA was added to the slurry of Sample A to prepare Sample C. 150 g and 250 g of OSA was added to Sample B slurries Sample D and Sample E, respectively, as shown in Table 2. With the use of a pH controller, pH was maintained between 7.5 and 7.6 with 3% NaOH until the reaction was complete. PH was adjusted to 5.5 with 3:1 HCl. The cakes were filtered and washed with tap water. The starch was ground and allowed to air dry.

TABLE 2

| | Sample C | Sample D | Sample E |
|---|---|---|---|
| Sample A + OSA (g) | 150 | | |
| Sample B + OSA (g) | | 150 | 250 |

### Example 4

This Example describes a method of preparing an hydroxypropylated starch.

200 g of sodium sulfate was slowly added to the starch slurry of Sample B at 35° C. and stirred until dissolved. 2500 g of 3% NaOH solution was slowly added. The slurry was evenly transferred into 1 L jugs. 250 g and 350 g of propylene oxide, as shown in Table 3 were added to each jug (Samples F and G, respectively). The jugs were placed in a tumbler machine and reacted overnight at 40° C. In the morning, the jugs were removed from the tumbler and opened carefully. The Samples were neutralized to pH 3.0-3.5 with 25% sulfuric acid, as needed. After allowing to mix for 1 hour the pH was adjusted to ˜5.5 with 3% NaOH. The cakes were filtered and washed with tap water. The starch was ground and allowed to air dry.

TABLE 3

| | Sample F | Sample G |
|---|---|---|
| Sample B + PO (g) | 250 | 350 |

### Example 5

This Example describes a method of preparing a highly converted acid modified starch by thermal processing.

4000 g of derivatized corn starch was added to a laboratory model fluid bed dryer (6 inch diameter by 15 inch high, Procedyne Corporation, New Brunswick, N.J.). The starch was fluidized with air in order to suspend the starch in the bed.

Anhydrous HCI gas was metered into the bed thorough the distributor plate. This produced a starch having a pH shown in Table 4. The amount of HCl added was determined by measuring the weight loss of the gas cylinder prior to and after the delivery of the gas into the reactor. Nitrogen gas was used to purge all lines prior to and after the addition of the acid in order to ensure that the actual amount of acid was contacted with the starch. The temperature of the air flowing into the bed and the temperature of the bed's jacket was then raised to a temperature shown in Table 4. After the period of time shown in Table 4 the starch was discharged from the bed. The resulting product had a flow viscosity shown in Table 4 and a white color similar to the initial starting material.

TABLE 4

| | Sample H | Sample I | Sample J | Sample K |
|---|---|---|---|---|
| % derivative | 3% OSA | 5% PO | 5% PO | 5% PO |
| HCl (anh.)* | 0.33 | 0.077 | 0.083 | 0.1383 |
| pH | 2.83 | 2.89 | 2.80 | 2.47 |
| Temperature (° F.) | 250 | 220 | 250 | 230 |
| Time (hours) | 4 | 1.5 | 1.5 | 2.0 |
| Flow viscosity (s) | 12.58 | 11.84 | 9.67 | 8.9 |

*% acid used by weight of dry starch

### Example 6

This Example describes a method of preparing adhesive formulations.

Adhesive formulations were prepared by first combining one of the starch samples exemplified above, corn syrup solids (available from Cerestar, Inc.) and a defoamer such as Foamaster NXZ, Foamaster 111, or Foamaster 333 (available from Cognis Corp.) with water in the amounts shown in Table 5. The mixture was heated to 180-190° F. and held at this temperature for 45 minutes until the starch was completely in solution. The starch solution was cooled to below 140° F. and a salt such as magnesium chloride, hexahydrate (available from IMC Kalium), and other formulating ingredients, such as dextrin stabilized homopolymer were added. The formulation was cooled below 125° F. and a preservative such as Kathon LX-1.5% added.

TABLE 5

| | Sample L | | Sample M | | Sample N | | Sample O | | Sample P | | Sample Q | | Sample R | |
|---|---|---|---|---|---|---|---|---|---|---|---|---|---|---|
| starch (Sample) | 134 | g(C) | 114 | g(F) | 80 | g(D) | 77 | g(G) | 114 | g(H) | 135 | g(I) | 77 | g(K) |
| corn syrup | 0 | g | 20 | g | 12 | g | 12 | g | 20 | g | 0 | g | 12 | g |
| defoamer | 1 | g | 1 | g | 2 | g | 2 | g | 0 | g | 0 | g | 1 | g |
| water | 134 | g | 133 | g | 75 | g | 81 | g | 135 | g | 135 | g | 81 | g |
| MgCl₃ (hex) | 130 | g | 131 | g | 81 | g | 81 | g | 130 | g | 130 | g | 81 | g |
| dextrin stabilized | 0 | g | 0 | g | 149 | g | 147 | g | 0 | g | 0 | g | 147 | g |
| homopolymer | | | | | | | | | | | | | | |
| preservative | 0.6 | g | 0.6 | g | 0.6 | g | 0 | g | 0.6 | g | 0.6 | g | 0.6 | g |

A variety of performance characteristics of Sample M and Sample Q were tested and compared to two samples (Comparative Sample S and Comparative Sample T) outside the scope of the invention. Comparative Sample S contained 175.0 g of a converted maize dextrin with a 7.7 second flow viscosity and 225.0 g of tap water. Comparative Sample T contained 135.0 g of a converted maize dextrin derivative (OSA) with 213.9 second flow viscosity, 135.0 g tap water, 130.0 g magnesium chloride, hexahydrate and 0.6 g Kathon LX (1.5%). Performance is reported in Table 6. Because of the large viscosity increase, Comparative Example T was not tested for machining or foaming characteristics.

TABLE 6

| Performance | | | Comparative | Comparative |
|---|---|---|---|---|
| Characteristic | Sample M | Sample Q | Sample S | Sample T |
| Viscosity | 1350 cps | 2750 cps | 400 cps | 1175 cps |
| Viscosity | <50% | <50% | <50% | >50% |
| Stability | viscosity | viscosity | viscosity | viscosity |
| | increase in | increase in | increase in | increase in |
| | one month | one month | one month | one month |
| Solids Content | 48.4% | 46.4% | 43.4% | 42.0% |
| Foaming | No foam | Moderate | No foam | — |
| Tendency | | amount of | | |
| | | foam | | |
| Machining | Acceptable: | Acceptable: | Un- | — |
| Characteristics | No throwing | No throwing | acceptable: | |
| | or splashing | or splashing | A great deal | |
| | from | from | of throwing | |
| | machine | machine | and | |
| | parts. Also | parts. Also | splashing | |
| | coated the | coated the | from | |
| | roller well. | roller well. | | |

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A water based adhesive comprising a converted starch derivative having a flow viscosity of between about 7 and about 20 seconds.

2. The adhesive of claim 1 wherein the adhesive further comprises a salt, a humectant, and/or a resin emulsion.

3. The adhesive of claim 2 wherein the humectant is dextrose, maltose or corn syrup solids.

4. The adhesive of claim 1 wherein the starch derivative is an organic anhydride modified starch or an hydroxy propylated starch.

5. The adhesive of claim 4 wherein the starch derivative is an octenylsuccinic anhydride modified starch.

6. The adhesive of claim 4 wherein the starch derivative is an propylene oxide modified starch.

7. The adhesive of claim 4 which has of flow viscosity of from about 9 to about 12 seconds.

8. The adhesive of claim 1 wherein the starch is derivatized following the conversion thereof.

9. The adhesive of claim 1 wherein the starch is derivatized then the derivatized starch is converted.

10. The adhesive of claim 1 wherein the starch is converted using an aqueous conversion process.

11. The adhesive of claim 1 wherein the starch is converted by acid, oxidation or thermal treatment.

12. An article of manufacture comprising the adhesive of claim 1.

13. The article of claim 12 which is an envelope.

14. A method of making an envelope comprising applying the adhesive of claim 1 to an envelope blank.

15. The method of claim 14 wherein the envelope blank is at least partially folded.
